(19) United States
(12) Patent Application Publication
(10) Pub. No.: US 2007/0264452 A1
(43) Pub. Date: Nov. 15, 2007

(54) System and method of how to transport liquids against gravity

(76) Inventor: Joseph Martin, Lexington, KY (US)

Correspondence Address: Joseph Martin;# 2204, 3600 Brookewind Way, Lexington, KY, 40515, US

(21) Appl. No.: 11/799,949

(22) Filed: May 3, 2007

Related U.S. Application Data
(60) Provisional application No. 60/798,686, filed on May 9, 2006.

(51) Int. Cl. B31B 45/00

(52) U.S. Cl. 428/34.1

(57) ABSTRACT

This is a system and method of how to transport liquids against gravity, this means from lower places to higher places, using the energy that the capillary tubes use. The structure of the system described in this application is a net that transports liquid. The materials with which the elements of this system are made of can be any always that the mentioned elements work as described in this application.

### REFERENCE TO PREVIOUS PROVISIONAL PATENT APPLICATION

U.S. Ser. No. 60/798,686.

### BACKGROUND OF THE INVENTION

This application relates to engineering, particularly to transportation of liquids.

The system described in this application gives an alternative to the transportation of liquids against gravity.

The systems mostly used today require the use of energy that comes from combustible fossils and/or electricity. This system uses the energy that capillary tubes use which doesn't produce contamination, it's always there and is never going to finish.

The object of the system described in this application is to use the alternative energy that is the energy used by the capillary tubes. This energy is clean, it's always there and it's not going to finish.

### SUMMARY

The system described in this application gives an alternative to how to transport liquids against gravity and an alternative of how to use the energy used by the capillary tubes.

### DETAILED DESCRIPTION

System and method of how to transport liquids against gravity.

The system is formed by one or more elements from the next list of elements:

Channels.
Containers.
Adapters of the extreme of the Channels.
Adapters of the containers.
Machines.
Subjections.
Field.
Transportation.
   and has the finality to transport liquids against gravity, this is from low places to high places, doesn't mater the distance or de difference of height between the origin point of the liquid and the destination point of the liquid, all this using the energy that capillary tubes use with liquids.

The system is conformed at list by one element called a channel, and can be conformed also by a channel or multiple channels and another element or other elements.

### Channel

The mission of a channel is to absorb liquid by it's beginning or beginnings and drop it by it's ending or endings.

A channel can be flexible or not flexible.

Parts:

Filling Dart:
It's made Of one of the following:
   A. Long and as thin as possible capillary tubes made of a material that attracts the liquid that we want to transport. These capillary tubes can be flexible or not flexible. These capillary tubes go from any beginning of the channel to any end of the same channel.
   B. Foam made of a material that attracts the liquid that we want to transport. The foam forms capillary tubes capable to absorb the liquid that we want to transport transporting it against gravity inside of the foam body.
   C. Short as thin as possible capillary tubes made of a material that attracts the liquid that we want to transport.
   D. Combination of two of A, B, C or combination of the three of them.

Cover:

The filling materials are contained by a cover that is resistant to the liquid that we want to transport and protects the filling materials from the outside.

This cover protects the inside of the channel and also forms the external skeleton of the channel that can be flexible or not flexible.

Filter

In the extremes of the channel that are the channel beginning or beginnings and the channel ending or endings the filling materials are maintained inside the cover by a filter that can be trespassed with no problem by the liquid that we want to transport and it can't be trespassed by the filling materials. This filter is united to the cover in a way that no filling materials can get outside the channel unless we take of the filter voluntarily.

When it's being used no point of the channel is lower than the one before and no higher than the next one being the one before the one that is nearer to the a beginning of the Channel and being the next one the one nearer from an end of the Channel.

In Case of Filling the Cover as In Case A. (Long Capillary Tubes).

The length of a channel is variable as you want it to be and the difference of height between the beginning of the channel and the end of the same channel is always less than the height that the liquid that we want to transport gets inside of the long and thickest capillary tube used to fill the channel.

In Case of Filling the Cover as in Case B. (Foam).

The length of a Channel is variable as you want it to be and the difference of height between the beginning of the Channel and the end of the same channel is always less than the height that the liquid that we want to transport gets inside a channel filled with this foam and which difference of height between its lowest point and it's highest point is larger than the height that the liquid that we want to transport gets inside of it.

In Case of Filling the Cover as Described in Case C. (Short Capillary Tubes).

The length of a Channel is variable as you want it to be and the difference of height between the beginning of the Channel and the end of the same channel can be any that you want because the liquid that we want to transport through this channel will get to any height inside of the channel in this case.

In Case of Filling the Cover as Described in Case D. (Combination).

The length of a Channel is variable as you want it to be and the difference of height between the beginning of the Channel and the end of the same channel is variable and always less than the height that the liquid that we want to transport is able to get inside the channel.

Limited by all said the cover can get any size and any structure so the channel can have one or more starting points an one or more ending points any ramifications and any body form.

The channels have to be adapted to the use that they are having and/or are going to have and to the other element or elements of the system where they are being used and/or are going to be used.

### Containers

The mission of the containers is to contain the liquid that we want to transport.

The walls of a container can be longer or not longer than the height of the container which is the measure from its bottom to the highest part of the walls.

There are two kinds of containers:
Those which depth is not variable.
Those which depth is variable.

The change of depth of the containers which depth is variable can happen because the bottom moves up or down or because the walls move up or down or the bottom and walls move one up and the other down or one down and the other up.

With all this there are two types of containers:
1—Those that have a tube that trespasses their bottom, tube thru which a channel can be connected so it can fill the container with the liquid that we want to transport. The length of this tube is the same than the length of the walls of the container.
   In the case that the depth of the container is variable and has a tube that trespasses its bottom this tube is able to move the same than walls do and at the same time.
2—Those which's bottom is not trespassed by anything and to be filled with the liquid that we want to transport this liquid has to come falling from a place higher than the walls of the container so this liquid falls inside the container.

With all this:
Seen from a higher place the two dimensions figure of the container in the plane of the bottom can be anyone.

These containers have to be adapted to the use that are having and/or are going to have and to the other element or elements of the system where are used and/or are going to be used.

### Adapters of the Extreme of the Channels

The mission of the adapters of the extreme of the channel is to optimize the control of the stream of the liquid that we want to transport.

The extremes of a channel can be the beginning or the beginnings or the ending or the endings of the channel.

The beginning or the beginnings of a channel is the point or are the points of the channel where the liquid that we want to transport is absorbed by the channel inside itself.

The ending or the endings of a channel is the point or are the points of the channel where the liquid that is being transported is expulsed out of the channel.

Point 1:

Adapters of the Beginning or the Beginnings of the First Channel or the Firsts Channels of the System:
A first channel of the system is the channel that absorbs the liquid that we want to transport from a place that mentioned liquid didn't get there by a channel of the system to which this channel is working for.
   Point 2:

Adapters of the Ending or the Endings of the Last Channel or Last Channels of the System:
A last channel of the system is a channel that drops the liquid that is being transported to a place from which no channel that works for the system takes it.

Adapters of the Beginning or the Beginnings and the End or the Ends of the Channels that are not the Beginning or the Beginnings or the Ending or the Endings Described before in Point 1 and in Point 2:

Mainly these adapters optimize the control of the stream of the liquid that is beig transported between any ending of a channel and any container and/or any container and any beginning of a channel.

The adapters of the extremes of the channels have to be adapted to the use that are having and/or are going to have and to the other element or elements of the system where they are being used and/or are going to be used.

### Adapters of the Containers

Mainly these adapters optimize the control of the stream of the liquid that is being transported between any ending of a channel and any container and/or any container and any beginning of a channel.

The adapters of the containers have to be adapted to the use that are having and/or are going to have and to the other element or elements of the system where they are being used and/or are going to be used.

### Machines

The mission of the machines is to provide us with the capacity of moving and/or transporting channels and/or containers.

These machines have to be able to hold one or more channels and/or one or more containers.

These machines are able to not move respect to the system that are working for.

There are two types of machines:
1. Machines that are able to move respect of the system that are working for.
2. Machines that are not able to move respect of the system that are working for.

The machines have to be able to move the channel or channels and/or the container or containers that are holding from one place to another and from one position to another. The machines of type 1 are also able to transport the channel or channels and/or the container or containers that are holding from one place to another.
A machine can move a channel or channels and/or a container or containers so the mentioned channel or channels and /or the next higher channel or channels next to the mentioned container or containers and higher than it or them stops or stop being in contact with the liquid with which was in contact in its or their lowest point.

The machines have to be adapted to the use that are having and/or are going to have and to the other element or elements of the system where they are being used and/or are going to be used.

### Subjections

The mission of the subjections is to subject two or more elements of the system.

Subjections Compatibility:
A subjection can be able to attach to two or more elements at the same time.
A subjection can be attached to another or others subjection or subjections.
When is needed that any element of the system have more than one subjection performing their function on it at the same time, any kind of subjection for any use, those subjections have to be able to perform their function at the same time.
Another type of subjection is a simple stick which size, that are it's length and thickness varies depending on the use given to it and to which the channel or channels climb. In the system we can use one, more than one or none of these subjections.

The subjections have to be adapted to the use that are having and/or are going to have and to the other element or elements of the system where they are being used and/or are going to be used.

### Field

The field is the place where the system is going to be built, is already built or is being built.

The field is considered an element of the system because all the other elements that are part of the system have to be adapted to it so they perform their function correctly.

### Transportation

The element called transportation refers to the transports that are going to transport the elements of the system.

Any of the elements that are susceptible of being part of the system have to be able to be transported except the field that doesn't necessarily have to be able to be transported from and to the place where the system is going to be built, is being built or is already built.

The transport is considered an element of the system because it has to be adapted to the other element or elements that are part of the system which also have to be adapted to the transport so every element of the system performs it's function correctly.

1. A system and method of how to transport liquids against gravity described in this application in DETAILED DESCRIPTION.

2. A channel of any type described in the description of the system mentioned in claim 1.

3. A container of any type described in the description of the system mentioned in claim 1.

4. An adapter of the extreme of a channel of any type described in the description of the system mentioned in claim 1.

5. An adapter of a container of any type described in the description of the system mentioned in claim 1.

6. A machine of any type described in the description of the system mentioned in claim 1.

7. A subjection of any type described in the description of the system mentioned in claim 1.
